(19) United States
(12) Patent Application Publication
(10) Pub. No.: US 2001/0016855 A1
(43) Pub. Date: Aug. 23, 2001

(54) Multi-dimensional table data management unit and recording medium storing therein a spreadsheet program

(76) Inventor: Yuko Hiroshige, Tokyo (JP)

Correspondence Address: Platon N. Mandros, BURNS, DOANE, SWECKER & MATHIS, L.L.P., P. O. Box 1404, Alexandria, VA, 22313-1404, US

(21) Appl. No.: 09/782,157

(22) Filed: Feb. 14, 2001

(30) Foreign Application Priority Data
Feb. 18, 2000 (JP) 2000-041848

(51) Int. Cl. G06F 17/24

(52) U.S. Cl. 707/503; 707/504; 707/509

(57) ABSTRACT

A multi-dimensional table data management unit inserts two bookmarks into a sequence of two-dimensional tables to define a plurality of tables, enclosed by the bookmarks, as a three-dimensional storage area (box). Normally, the unit defines a storage position, in which the item data of the box is stored, as three-dimensional data cubes (i, j, k). The multi-dimensional table data management unit allows the user to perform sorting, calculation, or box rotation of three-dimensional item data based on the three-dimensional item data.

### BACKGROUND OF THE INVENTION

1. Field of the Invention

The present invention relates to a multi-dimensional table data management unit, and more particularly to a data management technology for calculating item data in a table of three or more dimensions.

2. Description of the Related Art

Spreadsheet software or spreadsheet programs, such as, for example, Microsoft EXCEL, are tools for managing and calculating data using a two-dimensional table called a worksheet. In a conventional spreadsheet software program, such as that shown in FIG. 13, data is stored in data storage positions called “cell 1” in order to manage data. In a worksheet 2 composed of m rows and n columns, data stored in cells is represented by cells (i, j) (where, 1≦i≦m, 1≦j≦n). Data is displayed on the screen in units know as books, each of which is composed of one or more worksheets.

A typical conventional spreadsheet software program provides the user with functions such as an editing function, wherein rows or columns of data can be inserted or deleted and data can be copied and etc., for editing a two-dimensional worksheet; a calculation function for performing two-dimensional calculation on the row and column data using user-specified functions; a data management function such as sorting; and data analysis functions such as outline data analysis, data analysis using pivot-table function, and statistical analysis.

However, with conventional spreadsheet software programs, data is basically processed and stored in a two-dimensional worksheet and data management, calculation, and editing of data is performed in that worksheet. While it is possible to perform calculation while referencing data in other worksheets, the concept of three dimensions is implemented merely by overlaying one two-dimensional worksheet onto another. Data in each cell, defined as two-dimensional data, cannot be referenced directly as one data item. That is, to reference data in another worksheet, a user must create formulas or macros.

For example, when the cost of a plurality of projects is managed with the monthly incoming/outgoing status of each cost management item represented as a table, the three variables such as “cost management item”, “year and month”, and “project” are necessary to represent data structure. However, while three or more variables are frequently used as described above, with conventional spreadsheet software, these three categories can only be processed by overlaying worksheets.

Conventionally, two-dimensional worksheets must be combined to manage and edit multi-dimensional data. Therefore, ordinary users must use macros prepared by experienced users.

### SUMMARY OF THE INVENTION

The present invention seeks to solve the problems associated with the art described above. It is an object of the present invention to provide a multi-dimensional table data management unit which allows the user to easily manage n-dimensional (n is a natural number equal to or larger than 3) discrete data.

It is another object of the present invention to provide a medium recording therein a spreadsheet program which allows the user to easily manage n-dimensional (n is a natural number equal to or larger than 3) discrete data.

To achieve the above objects, a multi-dimensional table data management unit according to the present invention comprises table data management means for defining a data block as a processable data group, the data block being composed of a plurality of (n-1)-dimensional tables (n is a natural number equal to or larger than 3), and for defining item data of the processable data group as n-dimensional data for data management.

The multi-dimensional table data management unit may further comprise calculation processing means for executing a table calculation function based on the item data in each dimension of the data block.

The table data management means may execute a table editing function based on the item data of the data block in each dimension.

The table data management means may enclose a portion of a sequence of tables with punctuation tables to define the data block.

The present invention defines a data block of a plurality of (n-1)-dimensional tables as a processable data group and defines item data included in the processable data group as n-dimensional data, allowing the user to easily manage, edit, and analyze item data in any dimension.

A recording medium recording therein a spreadsheet program according to the present invention defines a data block as a processable data group, the data block being composed of a plurality of (n-1)-dimensional tables (n is a natural number equal to or larger than 3), and defines item data of the processable data group as n-dimensional data for data management.

The spreadsheet program may execute a table calculation function based on the item data in each dimension of the data block.

The spreadsheet program may execute a table editing function based on the item data of the data block in each dimension.

The spreadsheet program may process the data block defined by enclosing a portion of a sequence of tables with punctuation tables.

In the present invention, item data to be managed is represented an n-dimensional data to enable the user to easily manage, edit, and analyze n-dimensional data.

The medium storing therein the spreadsheet program may be installed on various types of device.

### BRIEF DESCRIPTION OF THE DRAWINGS

FIG. 1 is a functional block diagram showing the configuration of an embodiment of a multi-dimensional data management unit according to the present invention.

FIG. 2 is a diagram showing the concept of three-dimensional data to be processed in a preferred embodiment of the present invention.

FIG. 3 is a diagram illustrating the concept of three-dimensional data to be processed by the preferred embodiment of the present invention.

FIG. 4 is a diagram showing item data before and after sort processing by columns according to the preferred embodiment of the present invention.

FIG. 5 is a diagram showing item data before and after sort processing by rows according to the preferred embodiment of the present invention.

FIG. 6 is a diagram showing item data before and after sort processing by depth according to the preferred embodiment of the present invention.

FIG. 7 is a diagram showing the specification of the SUM function for calculating total values according to the preferred embodiment of the present invention.

FIG. 8 is a diagram showing two-dimensional data created by cutting a box.

FIG. 9 is a diagram showing a box that is rotated in the preferred embodiment.

FIG. 10 is a diagram showing a new box generated by sharing a part of two boxes.

FIG. 11 is a diagram showing a new box generated by extracting a part of two boxes.

FIG. 12 is a diagram showing a new b box generated by exclusive ORing two boxes.

FIG. 13 is a diagram showing conventional two-dimensional tables.

### DESCRIPTION OF THE PREFERRED EMBODIMENT

A preferred embodiment of the present invention will be described with reference to the attached drawings.

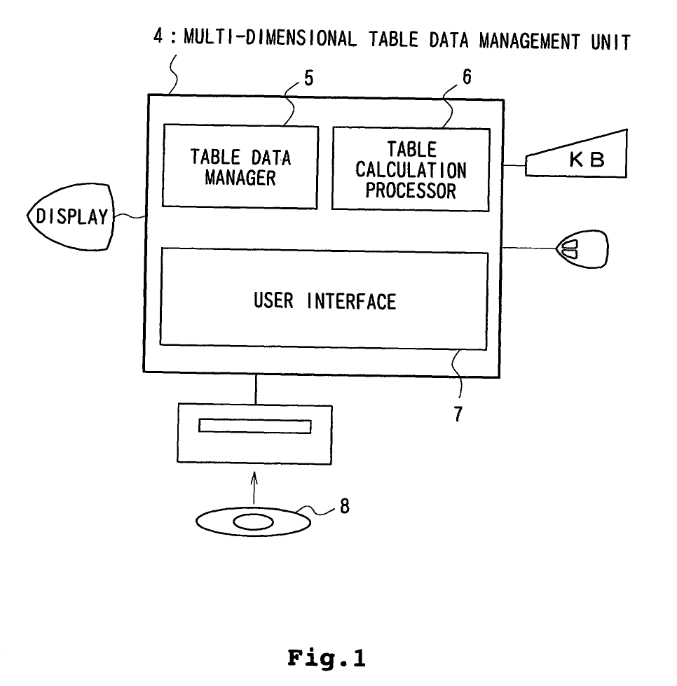

FIG. 1 is a functional block diagram illustrating a multi-dimensional table data management unit according to the present embodiment. The hardware of the multi-dimensional table data management unit may be a conventional computer if the spreadsheet program according to the present invention may be executed thereon. That is, a multi-dimensional data management unit 4 used in this embodiment is characterized, not in the hardware configuration, but in a table data manager 5 and a calculation processor 6 which execute the function associated with the spreadsheet program according to the present invention. In the example of this embodiment, the multi-dimensional data is of three dimensions.

The table data manager 5, which executes the data management function of the spreadsheet program, defines a data block, composed of a plurality of two-dimensional tables, as a processable data group. The unit also defines item data, included in the processable data group, as three-dimensional data for management. The calculation processor 6 executes the calculation function of the spreadsheet. A user interface 7, which controls the input/output of the input means (mouse, keyboard, etc.) and the output means (display, etc.), executes the interface between the user and the components of the multi-dimensional data management unit 4 including the table data manager 5 and the calculation processor 6. The table data manager 5, calculation processor 6, and user interface 7, when not pre-installed in the multi-dimensional data management unit 4, may be installed from a medium 8, such as a CD-ROM, on which the spreadsheet according to present invention is recorded. The medium 8 may be a CD-ROM, floppy disk, DVD, fixed disk, memory, and so on in which the spreadsheet program may be recorded. A network such as the Internet over which the spreadsheet may be transferred is also included as one medium from which the above-described components may be installed onto the multi-dimensional data management unit 4.

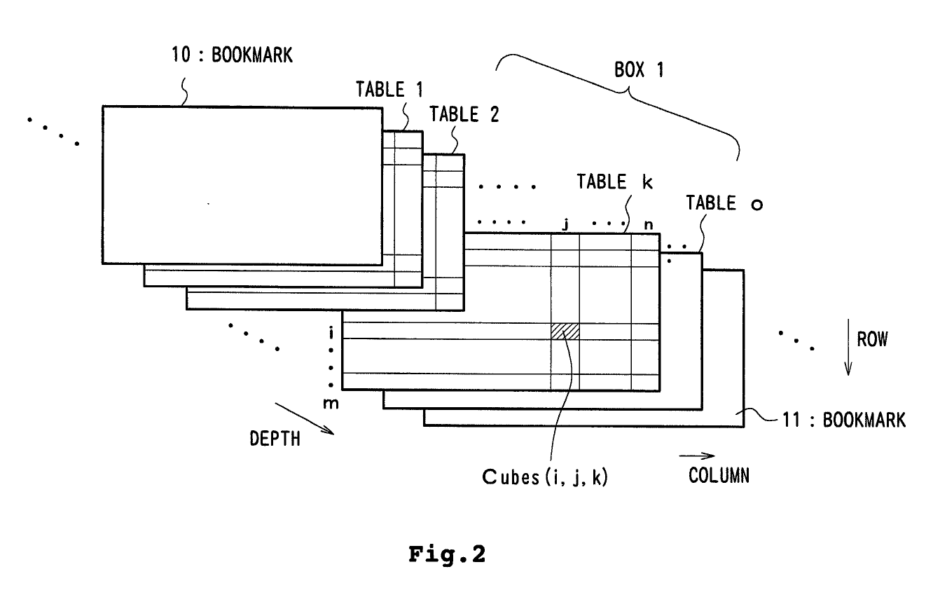

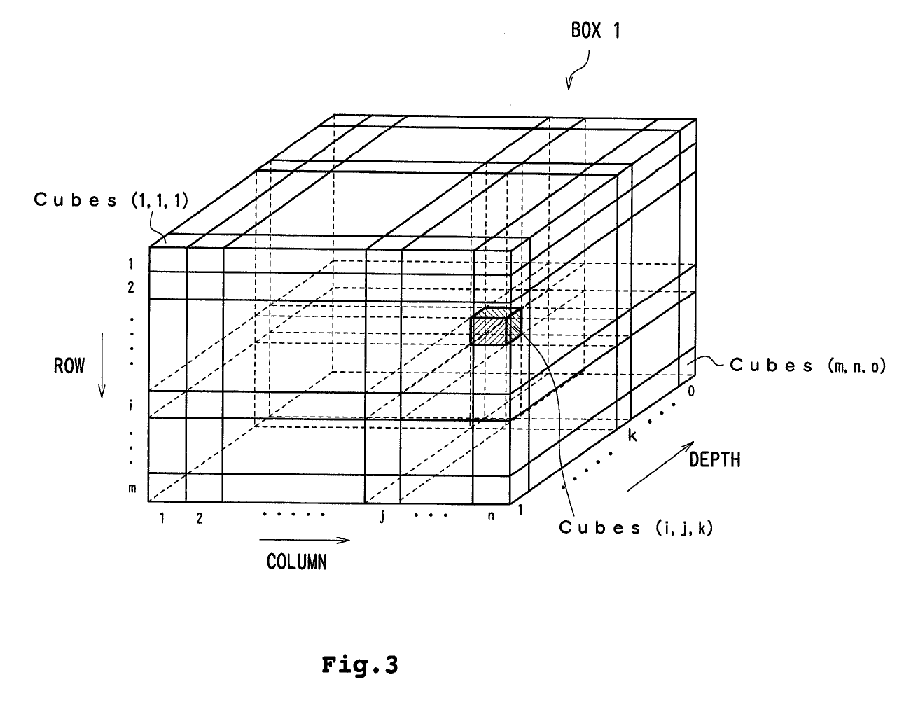

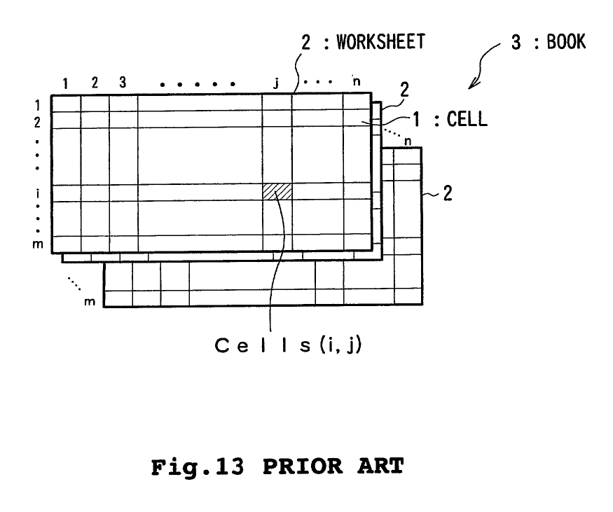

FIGS. 2 and 3 are conceptual diagrams showing data to be processed in this embodiment. In this embodiment, an example of the management of three-dimensional discrete data will be described. FIGS. 2 and 3 show the same data structure, with FIG. 2 being a conceptual diagram showing the comparison with a two-dimensional worksheet used by the conventional spreadsheet program shown in FIG. 13, and FIG. 3 being a conceptual diagram showing the technical concept of the present invention.

In the present embodiment, three-dimensional data is not managed simply by overlaying two-dimensional tables (worksheets). Rather, a three-dimensional area (data block) enclosed by punctuation tables, called bookmarks, is defined as a processable data group, and item data included in the processable data group is defined as three-dimensional data for data management. That is, in the conventional data management unit, discrete data is stored in worksheet data storage locations, called cells, with two-dimensional defined as cells (i, j) (where, 1≦i≦m, 1≦j≦n). In this embodiment, because three-dimensional discrete data is stored, a “cube” representing three dimensions is used instead of a cell. In this embodiment where three-dimensional is stored in each cube for data management, three-dimensional data located in row m, column n, and depth o is represented as cubes (i, j, k) (where, 1≦i≦m, 1≦j≦n, 1≦k≦o). In this embodiment, a data block defined by enclosing bookmarks is called a “box” instead of a conventional “book”.

As described above, in this embodiment, three-dimensional data is configured, not by overlaying two-dimensional tables, but by using a three-dimensional discrete data aggregate, that is, a box, and various functions of the conventional spreadsheet are applied to three-dimensional discrete data to allow the user to easily manage, edit, and calculate three-dimensional discrete data. In the description below, terminology used for conventional spreadsheets is sometimes used in order to enhance ease of understanding of the functions and concepts of this embodiment.

As shown in FIG. 2, bookmarks 10 and 11 are inserted into a sequence of tables, immediately before table 1 that is the first table of a box and immediately after table o that is the last table of the box, to define a processable data group. It should be noted that the tables before and after a box 1 are not shown in FIG. 2. For example, when calculating the yearly total in a sales data accumulation system where one table is created for each month, the bookmark 10 is inserted immediately before the table for January of the year and the bookmark 11 immediately after the table for December.

The bookmarks 10 and 11 are tables inserted to form a box. Any number of bookmarks may be inserted. A bookmark between two adjacent boxes indicates the end of the preceding box and, at the same time, the start of the following box. In the present embodiment, the bookmarks 10 and 11 are created not to store data, but to define a box. It is also possible that the first and last tables of a box contain information indicating the start and end of the box. In addition, for a processable data group composed only of all created tables, bookmarks may be omitted.

FIG. 3 is a diagram showing the features of the present embodiment. In FIG. 3, the box 1 is composed of m×n×o cubes, each cube containing a three-dimensional data cubes (i, j, k) (where, 1≦i≦m, 1≦j≦n, 1≦k≦o).

Next, how the processing function of a spreadsheet program is applied in this embodiment will be described.

As described above, in a three-dimensional table, a three-dimensional box is defined by inserting the bookmarks 10 and 11 into a sequence of two-dimensional tables. A box may also be defined by an application program or a macro.

Cutting three-dimensional data along its depth axis creates two-dimensional tables each composed of rows and columns. Because a three-dimensional table is similar in data structure to a plurality of two-dimensional worksheets, data is stored in a three-dimensional table the same manner data is stored into a two-dimensional table. In this embodiment, the title for each month, such as “Sales Result in January”, may be attached to each two-dimensional table created by cutting the box whose title is “Sales Result in 1999”.

In this embodiment, the data management function, calculation function, and data editing function may be executed for a box into which data has been stored as described above. In the description below, the sort function is described as one of the data management functions, and the total summary calculation function as one of the calculation functions. The extended function is also described. First, the data management function that sorts data in a box is described.

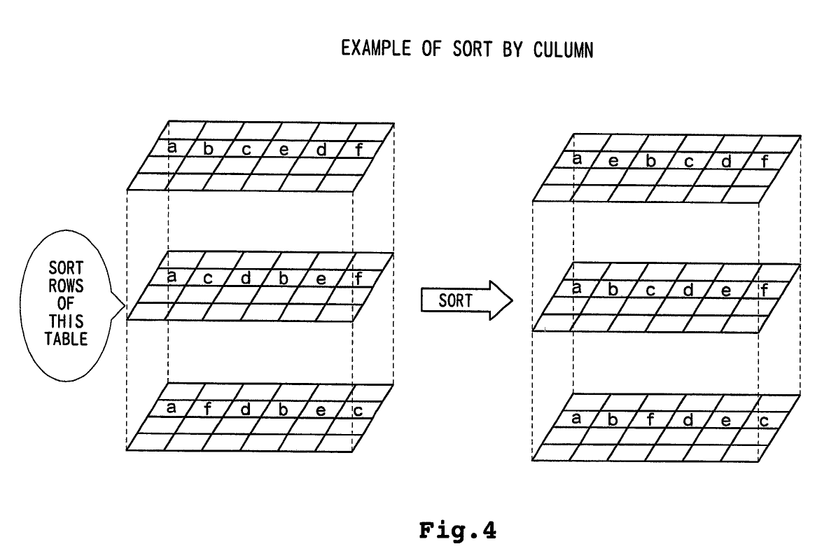

FIGS. 4-6 show an example of data before and after it is sorted into ascending order in the row direction, column direction, and depth direction of a three-dimensional table. Each figure shows a portion of data contained in a box composed of four rows, six columns, and three depth levels.

In FIG. 4, when data is sorted based on the item data in the second row in the second depth level, “a”, “c”, “d”, “b”, “e”, and “f”, the second row, which is the base row, is sorted into “a”, “b”, “c”, “d”, “e”, and “f”. In response to the sorted item data, the item data in the corresponding row-column positions in the second depth is also exchanged. That is, item data in a two-dimensional table at one particular depth level is sorted in this embodiment in the same manner as by the conventional spreadsheet program. In the present embodiment, in response to the sorted item data, the item data in the same row-column positions in the first and the third depth levels is also exchanged. For example, as a result of the sort, cubes (2, 2, 2)=“c” are moved to cubes (2, 3, 2). That is, it is moved from the second column to the third column and, in response to the sorted “c”, cubes (2, 2, 1)=“b” and cubes (2, 2, 3)=“f”, which are in the positions corresponding to “c” before the sort, are stored in the corresponding row-column positions cubes (2, 3, 1) and cubes (2, 3, 3), respectively. In response to the exchange of item data in the second depth level where sort is performed, the item data in depth levels 1 and 3 where sort is not performed may be sorted simply by changing the values representing the column storage positions of the item data. Therefore, in this embodiment, the sort function for a two-dimensional table may be used simply by correcting two-dimensional cells (i, j) to three-dimensional cubes (m, n, o). Special macros need not be created for this purpose.

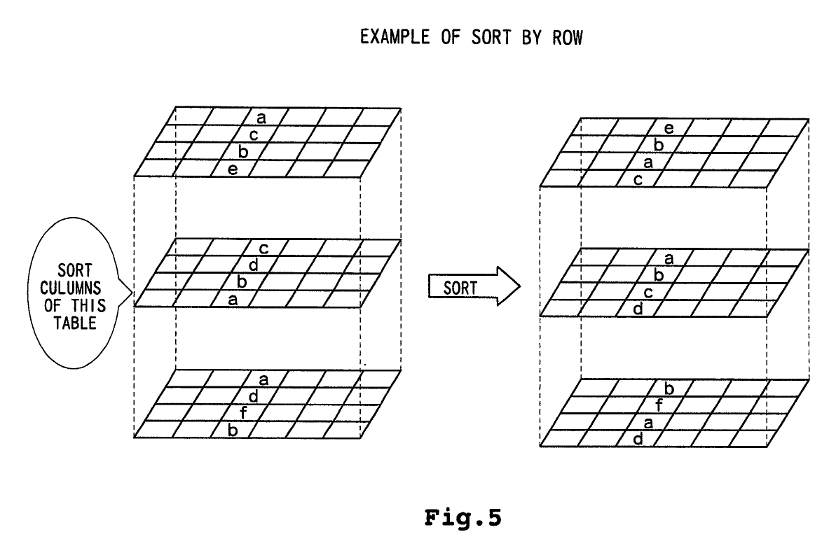

Once sort processing by columns is understood, sort processing by rows and by depth can be easily understood. In FIG. 5, when data is sorted based on the item data in the third column in the second depth level, “c”, “d”, “b”, and “a” in the third column, which is the base column, is sorted into “a”, “b”, “c”, and “d”. Then, in response to the sorted item data, the item data in the corresponding row-column positions in the second depth level is also exchanged and, in response to the sorted item data, the item data in the same row-column positions in the first and the third depth levels is also exchanged. For example, as a result of the sorting, cubes (1, 3, 2)=“c” are moved to cubes (3, 3, 2). That is, it is moved from the first row to the third row. And, in response to the sorted “c”, cubes (1, 3, 1)=“a” and cubes (1, 3, 3)=“a”, which are in the positions corresponding to “c” before the sort, are stored in the corresponding row-column position cubes (3, 3, 1) and cubes (3, 3, 3), respectively. Similarly, in response to the exchange of item data in the fourth column in the first and third depth levels, the storage positions of other item data in each depth level are also exchanged. In this embodiment, item data in the first and third depth levels where sorting is not performed may be sorted by simply changing the value representing the row storage positions.

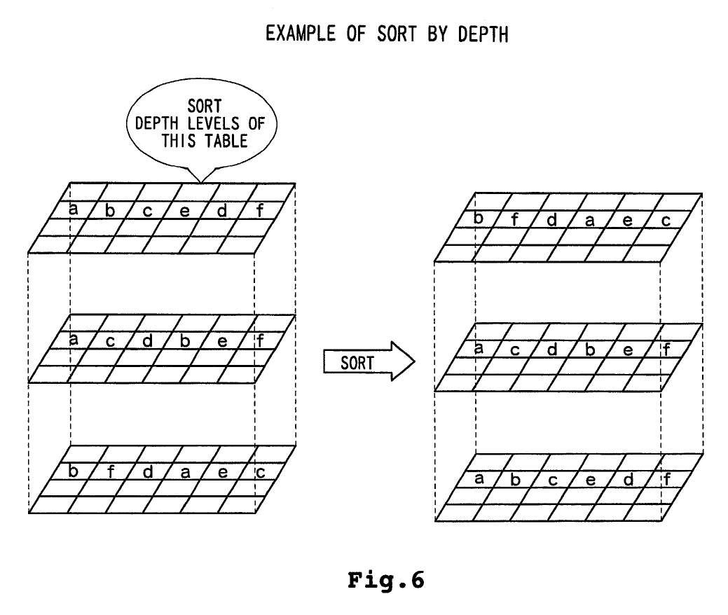

In addition, in FIG. 6, when item data is sorted based on the item data at the intersection of the second row and the fourth column in each depth level, “e”, “b”, “a” in the base row-column positions is sorted into “a”, “b”, and “e”. In response to the sorted item data, the item data in the corresponding positions, that is, in the different row-column positions at the same depth level, is also exchanged. For sorting by depth, only the depth positions of separated two-dimensional tables are exchanged. For convenience, FIG. 6 shows only the item data of one row.

In the example of this embodiment, item data is represented in three dimensions. Therefore, the item data in the row-column positions for which sort is not performed may be sorted simply by changing the numeric values representing the depth storage positions.

In addition, three-dimensional representation of item data allows data retrieval, heretofore only possible within a worksheet, to be performed easily in the depth direction.

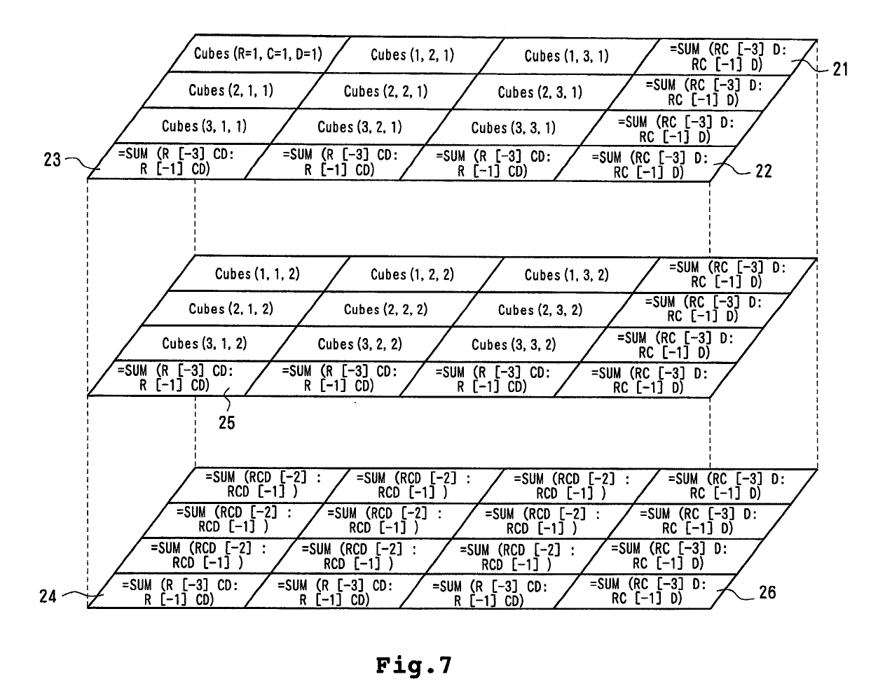

Next, FIG. 7 shows total calculation being performed by a SUM function, which is one of many possible calculation functions. A box, which is an aggregate of cubes shown in FIG. 3, is represented as a sheet for easy understanding. FIG. 7 shows a box of four rows, four columns, and three depth levels. In FIG. 7, “R” indicates a row, “C” indicates a column, and “D” indicates a depth. For example, cube 21 corresponding to cubes (1, 4, 1) contains the total value of the columns (first column to third column) in the first row in the first depth level. “=SUM(RC[−3]D: RC[−1] D)”, shown in FIG. 7, indicates that the value of “R” and the value of “C” are 1. On the other hand, the column “C” changes from the first column to the third column. That is, in cube 21 corresponding to cubes (1, 4, 1), the total of values in the third column to the first column before the cube is stored and, therefore, “C[−3]” and “C[−1]” are used. Therefore, “RC[−3]D”, “C[−3]RD”, and “RDC[−3]” are equivalent. In the generic description, the SUM function expression in each depth level is the same as shown in FIG. 7. More specifically, the content of cube 21 is “=SUM(Range (cubes (1, 1, 1), cubes (1, 3, 1)))”. Cube 22, which contains the total value of the columns in the fourth row in the depth level 1, may be described just like cube 21, may also be described as “=SUM(R[−3]CD: R[−1]CD)”, as in cube 23, because the cube 22 contains the total of the rows in the fourth column and the first depth level.

The table in the third depth level contains the total values of the tables in the first and second depth levels. The contents of the table in the third level are basically the same as those of the tables described above, except that the total value of depth levels, rather than the total value of rows or columns, is calculated. Cube 24 contains the total of cubes 23 and 25 which also contain total values. In FIG. 7, the total of the values in the same column in the same depth level is calculated. Instead of this total, the total of the same row-column positions in different depth levels may also be specified, for example, as “=SUM(RCD[−2]:RCD[−1])”. Cube 26 contains the grand total of item data (cubes (i, j, k) (i=1, 2, 3, j=1, 2, 3, k=1, 2)). In cube 26, a formula for calculating the total value of one row or the total value of one column in the same depth level (third depth level), or total value of one row-column in different depth levels, may be specified.

The SUM function is used as an example in the above description. In addition to this function, a plurality of item data from different rows, columns, and depth levels may be easily joined using a normal operator “+”, such as in “=cubes (1, 2, 3)+cubes (3, 4, 5)”.

In the present embodiment, item data and data stored in a total value storage position, such as the total of a row, are represented in three dimensions. This makes multi-dimensional operation easy.

The salient features of this embodiment will be described below.

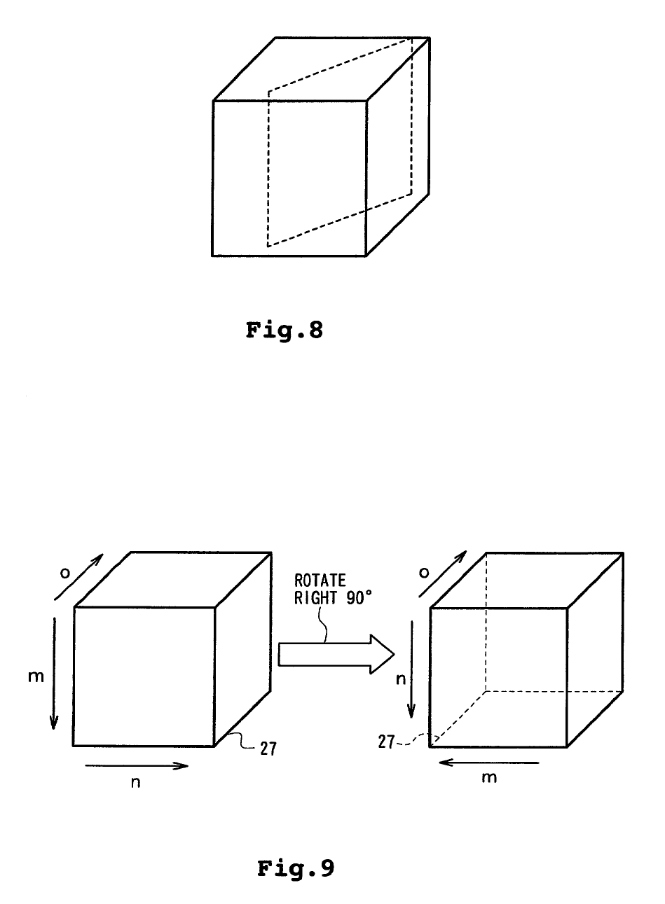

In this embodiment, item data is managed in a box-like three-dimensional area as shown in FIG. 3. Therefore, two-dimensional data of the cross section of a box that is made in any direction, for example in the diagonal direction as shown in FIG. 8, may be extracted, displayed, or printed. Moreover, both three-dimensional data and extracted two-dimensional data may be easily graphed.

In addition, when the rotation axis, rotation direction, and rotation angle is specified, the box may easily be rotated. FIG. 9 shows an example in which the box is rotated 90 degrees in the right direction with side 27 as the rotation axis. In this embodiment, rows and columns may be exchanged easily in this manner. Typically, a three-dimensional box is rotated 90 degrees with one of the sides or the center line as the rotation axis. However, the rotation of a box is not limited to such rotation.

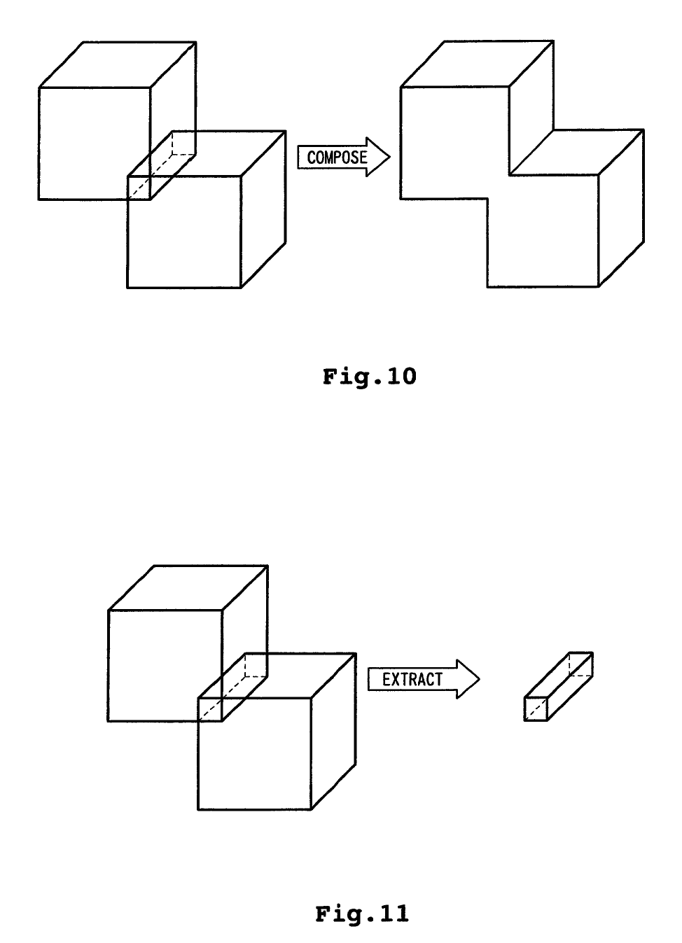

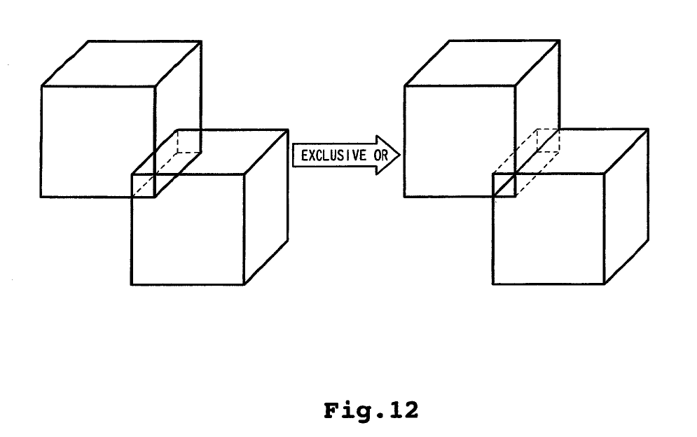

Furthermore, a new box may be easily generated by allowing a plurality of boxes to overlap or share data. In FIG. 10, a new box is generated by allowing two boxes to overlap partly. The total value of item data in the shared part is calculated, while other parts remain unchanged. In FIG. 11, a volume shared by two boxes is extracted as a new box to generate a new box, and the total value of item data in the extracted part is calculated. In FIG. 12, a new box is generated by calculating the exclusive OR, that is, by removing the shared portion.

In the example of the present embodiment, item data to be managed is represented as three-dimensional data to enable the user to easily manage, edit, and analyze three-dimensional data. In addition to the above description, allowing the user to specify the functions, originally prepared for two-dimensional data, for three-dimensional data through a conventional spreadsheet program makes it possible for the invention according to this embodiment to be applied to varied types of data analysis and macros. While in the above description, the present invention is applied to spreadsheet applications in the business area, the present invention may also be applied to the design area where three-dimensional matrix calculation is required.

In the example illustrating the preferred embodiment, three-dimensional data is used as an example of multidimensional data for simplicity of illustration and to clarify the difference between this embodiment and the conventional art. In addition to three-dimensional data, four or higher dimensional tables may also be defined as a data block simply by increasing the number of arguments attached to item data. That is, with multi-dimensional data represented as data (d1, d2, . . . , dn) (where n is a natural number equal to or larger than 3), the functions of the above-described embodiment using three-dimensional data cubes (i, j, k) may be applied to data of four or more dimensions.

Also, the functions described which are not provided by a conventional spreadsheet program for processing two-dimensional tables, such as, for example, data rotation function or data creation function, may be used for two-dimensional tables. Because a two-dimensional table is a box whose depth level is 1, this embodiment includes a conventional spreadsheet program prepared for processing two-dimensional tables.

While there has been described what are at present considered to be a preferred embodiment of the invention, it will be understood that various modifications may be made thereto, and it is intended that the appended claims cover all such modifications as fall within the true spirit and scope of the invention.

What is claimed is:

1. A multi-dimensional table data management unit comprising table data management means for defining a data block as a processable data group, the data block being composed of a plurality of (n-1)-dimensional tables (n is a natural number equal to or larger than 3), and for defining item data of the processable data group as n-dimensional data for data management.

2. The multi-dimensional table data management unit as claimed in claim 1, further comprising calculation processing means for executing a table calculation function based on the item data in each dimension of the data block.

3. The multi-dimensional table data management unit as claimed in claim 1, wherein said table data management means execute a table editing function based on the item data of the data block in each dimension.

4. The multi-dimensional table data management unit as claimed in claim 1, wherein said table data management means enclose a portion of a sequence of tables with punctuation tables to define the data block.

5. The multi-dimensional table data management unit as claimed in claim 4, wherein information indicating a start is added to a first table in the data block to make the first table act as the punctuation table.

6. The multi-dimensional table data management unit as claimed in claim 4, wherein information indicating an end is added to a last table in the data block to make the last table act as the punctuation table.

7. The multi-dimensional table data management unit as claimed in claim 1, wherein a title is attached to each of the tables of the data block.

8. The multi-dimensional table data management unit as claimed in claim 3, wherein, in response to a plurality of sorted item data for which sorting is specified in the data block and a sort direction thereof, said table data management means sort the entire data block by exchanging storage positions where item data for which the sorting is not specified is stored.

9. The multi-dimensional table data management unit as claimed in claim 3, wherein said table data management means rotate the data block according to a specified rotation axis, a rotation direction, and an angle to exchange storage positions of the item data.

10. The multi-dimensional table data management unit as claimed in claim 1, wherein said table data management means combine a plurality of data blocks to generate a new data block.

11. The multi-dimensional table data management unit as claimed in claim 10, wherein said table data management means combine and compose the plurality of data blocks to generate the new data block.

12. The multi-dimensional table data management unit as claimed in claim 10, wherein, when the plurality of data blocks are combined, said table data management means includes only a common portion to generate the new data block.

13. The multi-dimensional table data management unit as claimed in claim 10, wherein, when the plurality of data blocks are combined, said table data management means excludes only a common portion to generate the new data block.

14. A recording medium recording therein a spreadsheet program that defines a data block as a processable data group, the data block being composed of a plurality of (n-1)-dimensional tables (n is a natural number equal to or larger than 3), and defines item data of the processable data group as n-dimensional data for data management.

15. The recording medium according to claim 14 wherein said spreadsheet program executes a table calculation function based on the item data in each dimension of the data block.

16. The recording medium according to claim 14 wherein said spreadsheet program executes a table editing function based on the item data of the data block in each dimension.

17. The recording medium recording according to claim 14 wherein said spreadsheet program processes the data block defined by enclosing a portion of a sequence of tables with punctuation tables.
